(19) United States
(12) Patent Application Publication
(10) Pub. No.: US 2005/0206168 A1
(43) Pub. Date: Sep. 22, 2005

(54) Float type base structure for wind power generationon the ocean

(76) Inventors: Mitsunori Murakami, Osaka (JP); Kozo Oba, Osaka (JP)

Correspondence Address: Brinks Hofer;Gilson & Lione, PO Box 10395, Chicago, IL, 60610, US

(21) Appl. No.: 10/506,023

(22) PCT Filed: Feb. 27, 2003
(86) PCT No.: PCT/JP03/02284

§ 371 Date: Apr. 25, 2005

(30) Foreign Application Priority Data
Feb. 27, 2002 (JP) 2002-51609

(51) Int. Cl. F03D 9/00; H02P 9/04

(52) U.S. Cl. 290/55

(57) ABSTRACT

The present invention relates to a floating-type foundation structure that supports a power generation system upon the ocean in the upright position. The foundation structure comprises: a main floating body consisting of a cylinder that is longer in the axial direction disposed such that its central axis becomes vertical so as to support the power generation system in the upright position; and auxiliary floating bodies attached to the main floating body by trusses so as to surround the main floating body. The lower portion of the main floating body that supports the power generation system in the upright position is submerged in the ocean while the upper portions of the auxiliary floating bodies are positioned upon the ocean surface. A flat plate larger in diameter than the cross section of the main floating body is installed so as to be as close to horizontal as possible in the underwater portion below the waterline of the main floating body.

### BACKGROUND

1. Field of the Invention

The present invention relates to a floating foundation structure for offshore wind power generation facilities that are completely independent of the seafloor topography.

2. Background of the Invention

Now that the effective utilization of natural energy sources is being pursued, wind power generation is expanding even in Japan at a remarkable pace, particularly because of experiments that have proved profitable.

Particularly in Europe, the construction of wind power generation facilities has recently been proceeding not only on land but also offshore. This offshore wind power generation differs from wind power generation on land not only in that a stable amount of wind flow can be expected but also it does not cause noise, electromagnetic or other kinds of pollution that may interfere with the life of the citizenry, so its promise for broad adoption is great.

However, the offshore wind power generation facilities that are actually operating in Europe are all of one of several forms that are installed on the seafloor, including the caisson type (see FIG. 12(a)), the monopile type (see FIG. 12(b)) or the dolphin type (see FIG. 12(c)). Note that in FIGS. 12(a), 12(b) and 12(c), 2 indicates a power generation system, consisting of a tower 2a, a nacelle 2b and blades 2c.

With an offshore wind power generation facility of this type, as the water depth increases, the construction work becomes more complex and the construction expenses increase rapidly. They are also greatly affected by the seafloor geology, so while construction is possible in shallows up to a depth of roughly 20 meters, construction becomes nearly impossible in deeper ocean areas.

There is a trend in Japan also to move the construction of wind power generation facilities from land to offshore. However, in comparison to Europe, Japan has a much smaller area of shallow seafloor topography, so it is difficult to adopt the same foundation structures as those used in Europe for seafloor construction.

The present invention came about in light of the aforementioned problems and has as its object to provide a floating foundation structure for offshore wind power generation that has superior stability characteristics particularly with respect to waves, and not only is nearly unaffected by water depth but also is completely unaffected by the seafloor topography.

### SUMMARY OF THE INVENTION

The present invention is a floating-type foundation structure that supports a power generation system upon the ocean in the upright position, where the power generation system consists of a tower, a nacelle secured to the top end of the tower, and blades that are rotatably attached to the front end of this nacelle, wherein: this foundation structure comprises: a main floating body consisting of a cylinder that is longer in the axial direction disposed such that its central axis becomes vertical so as to support the power generation system in the upright position, and auxiliary floating bodies attached to the main floating body by trusses so as to surround the main floating body, and the lower portion of the main floating body that supports the power generation system in the upright position is submerged in the ocean while the upper portions of the auxiliary floating bodies are positioned upon the ocean surface.

With the present invention, the power generation system floats upon the surface of the ocean due to the buoyancy of the main floating body and auxiliary floating bodies, so not only is it virtually unaffected by water depth, but the ocean topography is no problem at all. Moreover, by disposing the main floating body in the shape of a cylinder longer in the axial direction such that its central axis is vertical and its lower portion is submerged in the ocean, a superior effect of suppressing horizontal motion and tilting (rotation) due to waves is achieved. In addition, by providing a plurality of auxiliary floating bodies attached to the main floating body by trusses so as to surround the main floating body such that their upper portions are positioned on the ocean surface, it has adequate restoration force with respect to steady wind loads, and thus a superior meritorious effect is achieved even with respect to the suppression of vertical motion due to waves.

In addition, the present invention comprises the present invention described above, wherein a flat plate larger in diameter than the cross section of the main floating body is installed so as to be as close to horizontal as possible in the underwater portion below the waterline of the main floating body. This flat plate further improves the effect of suppressing vertical motion and tilting (rotation) due to waves.

In addition, the present invention comprises one of the present inventions described above, wherein resistance plates are provided in the underwater portion below the waterline of the main floating body. These resistance plates allow the dynamic tilting (rotation) due to waves to be further suppressed.

In addition, the present invention comprises one of the present inventions described above, wherein at least two oscillation-suppression members are moveably provided at opposite positions upon the circumference above the waterline of the foundation structure. These oscillation-suppression members are able to control large degrees of tilting due to wind in particular.

Moreover, when these oscillation-suppression members are constituted such that each is independently moveable, the control of large degrees of tilting due to wind can be performed easily.

In addition to the constitutions described above, the present invention further comprises oscillation-suppression vanes provided in the underwater portion of the foundation structure. During oscillation due to waves, seawater can pass unimpeded between these oscillation suppression vanes, so the tips of the vanes flex, and thus the vortex flow given off from the tip increases the hydrodynamic force, namely the oscillation suppression, in the direction perpendicular to the surface of the oscillation suppression vanes, thereby further increasing the oscillation suppression ability of the floating-type foundation structure.

By providing these oscillation-suppression vanes as far as possible toward the outside of the foundation structure, for example, on the outer periphery portions of the auxiliary floating bodies, the effect described above becomes even more marked.

In addition, the present invention comprises one of the present inventions with oscillation-suppression members provided as described above, wherein, instead of the oscillation-suppression members, the auxiliary floating bodies each contain a stipulated amount of ballast water, and also a pump is provided on at least one of each of the pairs of auxiliary floating bodies disposed opposite each other symmetrically about the center of the floating-type foundation structure, and the pump distributes the ballast water within the pairs of oppositely disposed auxiliary floating bodies. With this constitution, the functions and meritorious effects in the case of providing oscillation-suppression members can be achieved with a simple structure.

A pump needs not necessarily be provided on all auxiliary floating bodies, but when not provided on all auxiliary floating bodies, they should be disposed so that they are not clustered on one side in consideration of the balance of the foundation structure.

Moreover, in addition to the constitution described above, if a pump is provided in a portion excluding the auxiliary floating bodies of the foundation structure, that ballast water to be distributed can be replenished. From the standpoint of balance, this pump is preferably provided toward the center of the floating-type foundation structure.

### BRIEF EXPLANATION OF THE DRAWINGS

FIG. 1 is a schematic explanatory diagram of the floating foundation structure for offshore wind power generation according to the present invention when viewed from the side;

FIG. 2(a) is a cross section along A-A of FIG. 1;

FIG. 2(b) is an explanatory diagram of the operation of the oscillation-suppression vanes in FIG. 2(a);

FIGS. 3(a) and (b) are explanatory diagrams of the oscillation-suppression members, where FIG. 3(a) is a cross section when viewed from above and FIG. 3(b) is a cross section along arrows A-A of FIG. 3(a);

FIG. 4 is a schematic explanatory diagram of another example of the floating foundation structure for offshore wind power generation according to the present invention when viewed from the side;

FIG. 5(a) is a cross section along A-A of FIG. 4;

FIG. 5(b) is an explanatory diagram of the operation of the example shown in FIG. 4;

FIG. 6 is an explanatory diagram of the operation of another example shown in FIG. 4;

FIGS. 7(a) and (b) are explanatory diagrams of models used in experiments, where FIG. 7(a) is a diagram of an example wherein the main floating body is disk-shaped, and FIG. 7(b) is a diagram of an example wherein the main floating body has a large-diameter flat plate provided on the bottom surface of a cylinder that is longer in the axial direction;

FIGS. 8(a), (b) and (c) are explanatory diagrams of the oscillation modes used in the example illustrated in FIG. 7(a), where FIG. 8(a) is an explanatory diagram of horizontal motion, FIG. 8(b) illustrates vertical motion and FIG. 8(c) illustrates tilting (rotation);

FIG. 9 is a graph comparing the response in horizontal motion among the examples illustrated in FIGS. 7(a) and (b);

FIG. 10 is a graph comparing the response in vertical motion among the examples illustrated in FIGS. 7(a) and (b);

FIG. 11 is a graph comparing the response in tilting (rotation) among the examples illustrated in FIGS. 7(a) and (b); and

FIGS. 12(a), (b) and (c) are explanatory diagrams illustrating the forms of foundation structures for an offshore wind power generation facility when installed on the seafloor, where FIG. 12(a) illustrates the caisson type, FIG. 12(b) the monopile type and FIG. 12(c) shows the dolphin type.

### DETAILED DESCRIPTION OF THE PRESENTLY PREFERRED EMBODIMENTS

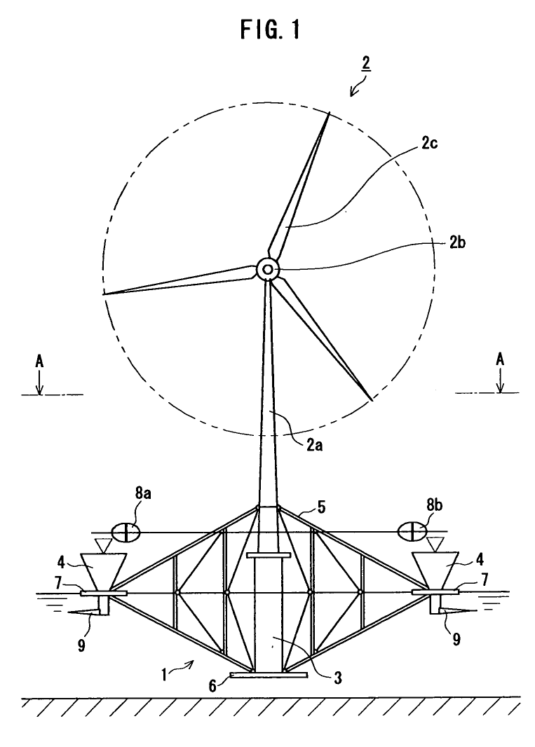

Here follows a more detailed description of the present invention made with reference to the appended drawings in FIGS. 1-6.

In FIGS. 1-6, 1 is a floating-type foundation structure according to the present invention that supports a power generation system 2 upon the ocean in the upright position, where a constitution as described below is adopted. Note that the power generation system 2 consists of a tower 2a, a nacelle 2b that encloses a generator and that is secured to the top end of the tower 2a, and blades 2c that are rotatably attached to the front end of this nacelle 2b in a radial manner.

3 is a main floating body consisting of a cylinder that is longer in the axial direction and that supports the power generation system 2 in the upright position. In order to achieve a superior effect of suppressing horizontal motion and tilting (rotation) due to waves, this main floating body 3 may be mounted coaxially to the tower 2a, for example, so that its central axis becomes vertical.

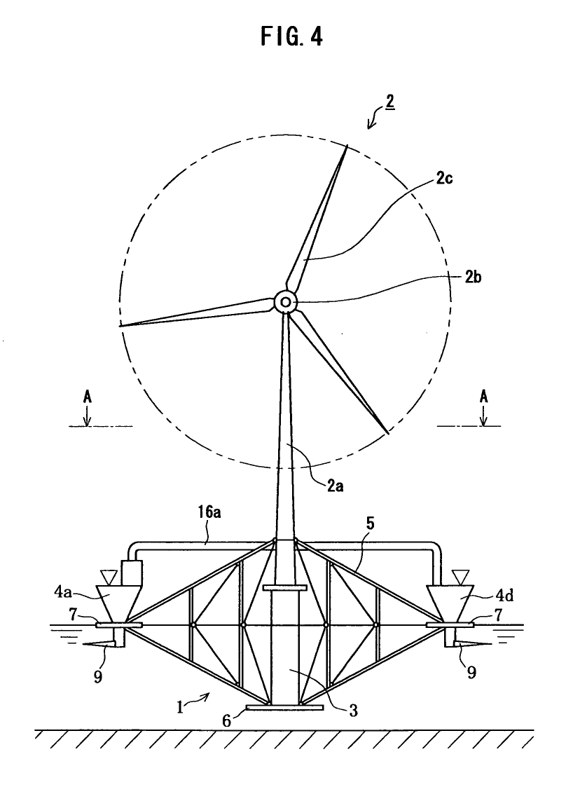

4 indicates auxiliary floating bodies that supplement the buoyancy of the main floating body 3 and also are provided such that their upper portion is positioned on the ocean surface in order to control the restoration force of the main floating body 3 when the power generation system 2 supported by the main floating body is rotated, or tilted, due to waves. FIGS. 1-3 illustrate examples where eight of these auxiliary floating bodies are provided, while FIGS. 4-6 are examples where six are provided.

These auxiliary floating bodies 4 are attached to the main floating body 3 by trusses 5 so as to surround the main floating body 3 at equiangular positions at the same radii from the main floating body 3 as the center. In the examples illustrated in FIGS. 1-6, as shown in FIGS. 1 and 4, the upper portion positioned upon the ocean surface has the shape of an inverted truncated cone (the shape of a cone with its top portion cut off and then inverted vertically), while the lower portion that is immersed in the ocean has the shape of a cylinder. By adopting such a shape, a superior effect is achieved with respect to the restoration force which acts on the power generation system supported by the main floating body when rotated, or tilted, due to waves.

With the floating-type foundation structure 1 according to the present invention, the total buoyancy of the main floating body 3 and auxiliary floating bodies 4 is determined so as to submerge in the ocean the lower portion of the main floating body 3 which, together with the auxiliary floating bodies 4, supports the power generation system 2 in the upright position. By doing so, the center of gravity can be lowered to maintain adequate restoration force so that the power generation system 2 does not capsize on the ocean. In addition, it is possible to suppress fluctuations in buoyancy and oscillations due to wind and waves.

In addition, in the examples shown in FIGS. 1-6, in addition to the main floating body 3 and auxiliary floating bodies 4 described above, a flat plate 6, resistance plates 7, oscillation suppression members 8a and 8b, oscillation suppression vanes 9 and the like to be described below are also attached.

6 is a disk-shaped flat plate of a diameter larger than the cross section of the main floating body 3, being installed horizontally in the underwater portion below the waterline of the main floating body 3, for example, on the bottom surface. Moreover, by attaching this flat plate 6 to the main floating body 3, the effect of suppressing vertical motion and tilting (rotation) due to waves can be further improved.

7 indicates ring-shaped resistance plates that may be provided at the waterline position, for example, in a form such that they are fit to the outside of the auxiliary floating bodies 4 at the waterline position. These resistance plates 7 can be provided to suppress tilting (rotation) due to waves even further. These resistance plates 7 need not necessarily be provided on all of the auxiliary floating bodies 4. This example presents ones attached at the waterline in order to set the point of application of force above the ocean surface, but they may also be provided in the underwater portion below the waterline.

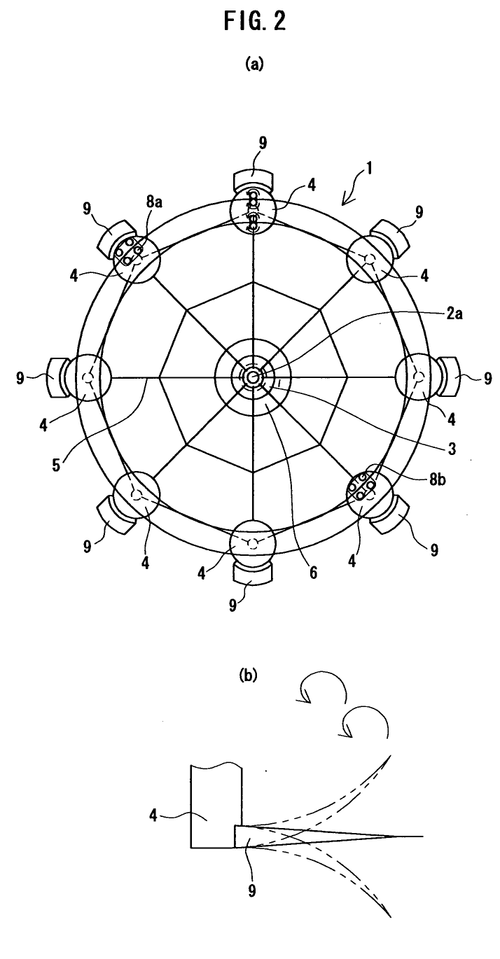

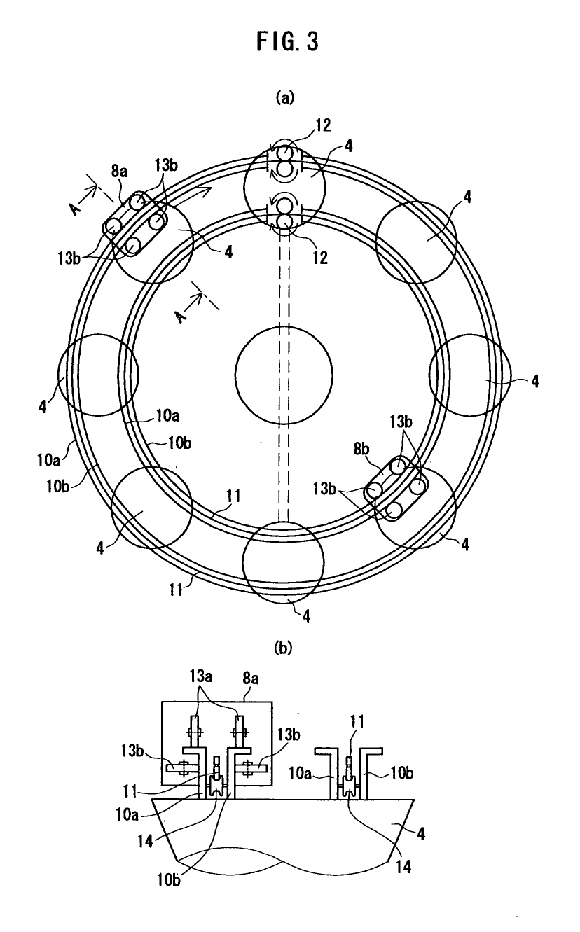

In FIGS. 1-3, 8a and 8b are oscillation suppression members, where two members, for example, may be moveably provided at a position above the waterline of the foundation structure 1. In a calm state, these oscillation suppression members 8a and 8b maintain the balance of the power generation system 2 in the upright position on the ocean, being located at opposite positions upon the circumference of a circle as shown in FIG. 2(a) and FIG. 3(a).

In the event that wind blows from the north to the south in this state, for example, the power generation system 2 will begin to tilt toward the south, so the oscillation suppression members 8a and 8b are moved toward the north side to maintain the balance. At this time, there is no need for the two oscillation suppression members 8a and 8b to be both moved until reaching a position at due north, but rather it is sufficient for them to move to a position to the north side of the line connecting east to west, thus preventing tilting.

The mechanism for moving the two oscillation suppression members 8a and 8b adopts the constitution described below in the example illustrated in FIG. 3.

10a and 10b are a pair of rails laid in a ring shape upon the upper surfaces of the auxiliary floating bodies 4, and between these rails 10a and 10b are rotatably installed a plurality of guide rollers 14. Moreover, a chain 11 that is supported such that it is stretched tight upon these guide rollers 14 is moved by one primary drive 12 that may be installed on one of the auxiliary floating bodies 4, for example.

By moving this chain 11, rollers 13a and 13b that roll along the top surface and side surfaces of the individual rails 10a and 10b are moved along the oscillation suppression members 8a and 8b that are rotatably attached and also are secured to and hold the chain 11.

The mechanism for moving the two oscillation suppression members 8a and 8b is not limited to the above constitution. For example, it is possible to use two primary drives for movement in order to prevent shock at the time of changing the rotary orientation. In addition, the primary drive 12 may be disposed below the rails 10a and 10b, for example, in order to avoid interfering with the motion of the oscillation suppression members 8a and 8b.

In the example shown in FIG. 3, two sets of the paired rails 10a and 10b are provided, one inside and one outside, thus giving a constitution whereby the oscillation suppression members 8a and 8b can each move independently. With this constitution, the control of large degrees of tilting can be easily performed. Note that the paired rails 10a and 10b may also be disposed above and below in circles of the same circumference, instead of as in the example shown in FIG. 3.

In addition, FIGS. 4-6 show an example that adopts the following structure in order to maintain the balance of the power generation system 2, instead of moving the oscillation suppression members 8a and 8b as described above.

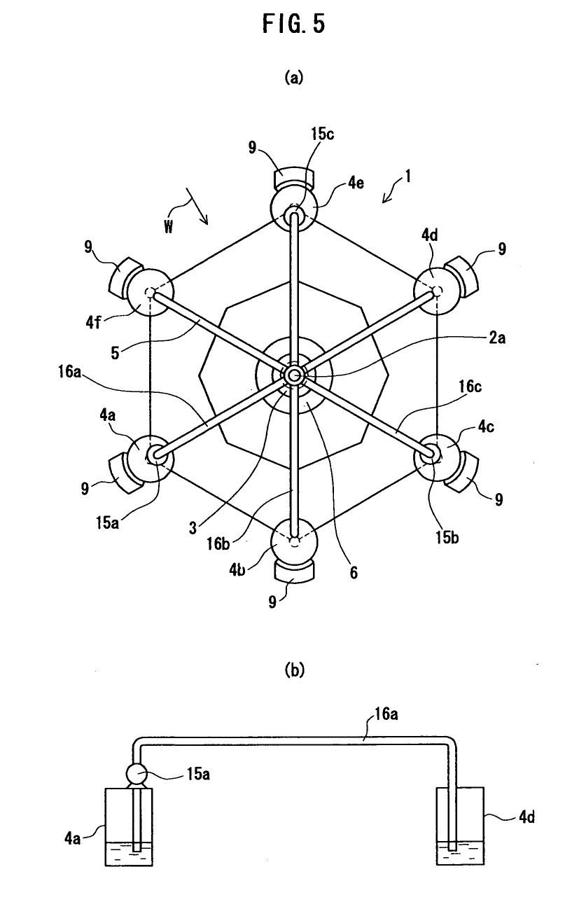

15 indicates pumps provided on the auxiliary floating bodies 4. In the example of FIG. 5, among the pairs of auxiliary floating bodies 4a and 4d, 4b and 4e, and 4c and 4f disposed opposite each other symmetrically about the center of the floating-type foundation structure 1, pumps 15a, 15b and 15c may be provided on auxiliary floating bodies 4a, 4c and 4e, for example, in consideration of the overall balance.

In the example illustrated in FIGS. 4-6, as shown in FIG. 5(b), the auxiliary floating bodies 4a through 4f each contain a stipulated amount of ballast water. Moreover, the ballast water within the pairs of oppositely disposed auxiliary floating bodies 4a and 4d, 4b and 4e, and 4c and 4f is distributed by the pumps 15a-15c through pipes 16a-16c that connect each of the pairs of oppositely disposed auxiliary floating bodies 4a and 4d, 4b and 4e, and 4c and 4f.

In a calm state, as shown in FIG. 5(b) for example, the ballast water is distributed equally between the oppositely disposed auxiliary floating bodies 4a and 4d, 4b and 4e, and 4c and 4f.

In this state, when wind blows in the direction indicated by the arrow W in FIG. 5(a), the power generation system 2 tilts toward the downwind direction indicated by arrow W. Accordingly, pumps 15b and 15c are driven to pump ballast water from auxiliary floating body 4b to auxiliary floating body 4e, and also pump ballast water from auxiliary floating body 4c to auxiliary floating body 4f.

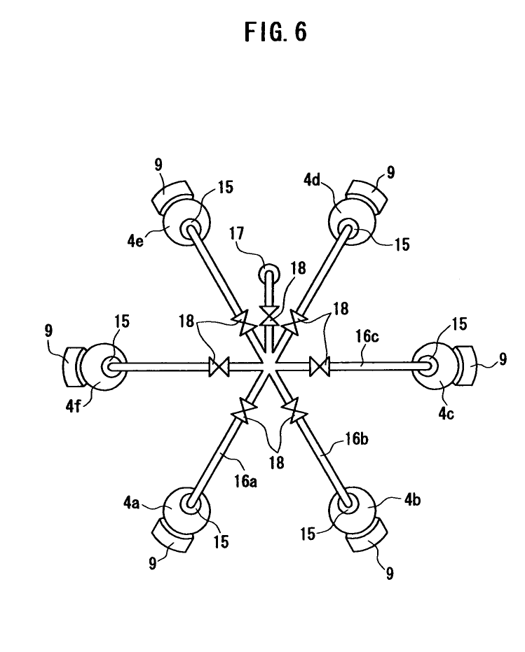

FIG. 6 illustrates an example wherein pumps 15 are provided on all of the auxiliary floating bodies 4a-4f. In addition, in FIG. 6, the pipes 16a-16c that connect each of the pairs of oppositely disposed auxiliary floating bodies 4a and 4d, 4b and 4e, and 4c and 4f are connected at the center of the floating-type foundation structure 1, and thus the distribution of ballast water is performed by controlling the opening and closing of valves 18 provided at positions slightly separated from the center. Moreover, in FIG. 6, in addition to the constitution of FIG. 4 and FIG. 5, one more pump 17 is provided in a portion excluding the auxiliary floating bodies 4a-4f of floating-type foundation structure 1. When this pump 17 is provided, in the event that the amount of ballast water to be distributed becomes insufficient, it can be replenished. From the standpoint of balance, this pump 17 is preferably provided as close to the center of the floating-type foundation structure 1 as possible.

9 represents oscillation suppression vanes installed at the outside edge on the bottom surface of all of the auxiliary floating bodies 4 making up the floating-type foundation structure 1. These oscillation suppression vanes 9 are each provided with appropriate gaps between as shown in FIGS. 2(a) and (b), FIG. 5(a) and FIG. 6 so that seawater can pass unimpeded when the floating-type foundation structure 1 oscillates. Moreover, they are given a flexible-vane structure such that their tips can flex during oscillation, as illustrated by the imaginary lines in FIG. 2(b).

Accordingly, during oscillation, seawater can pass unimpeded between adjacent oscillation suppression vanes 9, so the tips of the vanes flex as seawater passes, and thus the vortex flow given off from the tip increases the hydrodynamic force, namely the oscillation suppression, in the direction perpendicular to the surface of the oscillation suppression vanes 9, thereby further increasing the oscillation suppression ability of the floating-type foundation structure 1. By adopting such a flexible-vane structure, it is possible to prevent the concentration of stress at the vane root, thus increasing the safety of the system.

Note that while this is omitted from the drawings, the floating-type foundation structure 1 for offshore wind power generation according to the present invention naturally has a mooring apparatus for mooring the foundation structure 1. In addition, the floating-type foundation structure 1 for offshore wind power generation according to the present invention is preferably fabricated from FRP in order to reduce weight.

In passing, here follows a description of the results of experiments performed in order to confirm the meritorious effects of the main floating body 3 of the present invention.

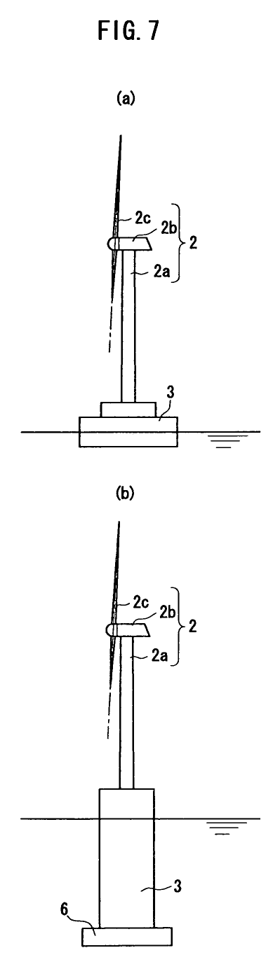

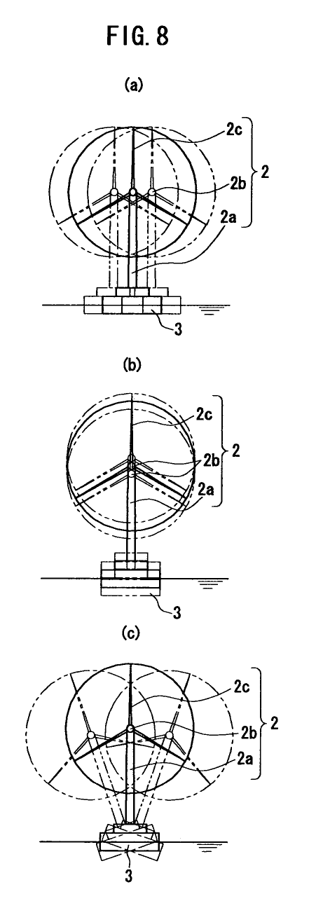

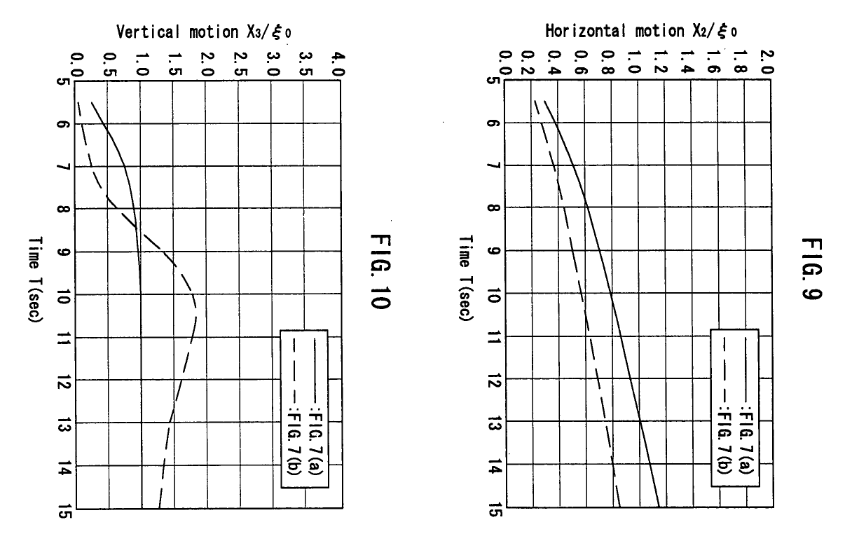

FIG. 7 is an explanatory diagram of a model used in experiments, where FIG. 7(a) is a diagram of an example wherein the main floating body 3 is disk-shaped, and FIG. 7(b) is a diagram of an example wherein the main floating body 3 has a large-diameter flat plate 6 provided on the bottom surface of a cylinder that is longer in the axial direction.

In order to analyze the frequency-response characteristics with respect to regular waves, the aforementioned model's horizontal motion (see FIG. 8(a)), vertical motion (see FIG. 8(b)) and tilting (rotation) (see FIG. 8(c)) were analyzed. At the time of analysis, restraint due to the mooring is not taken into consideration but rather the main floating body 3 is taken to be a freely oscillating body.

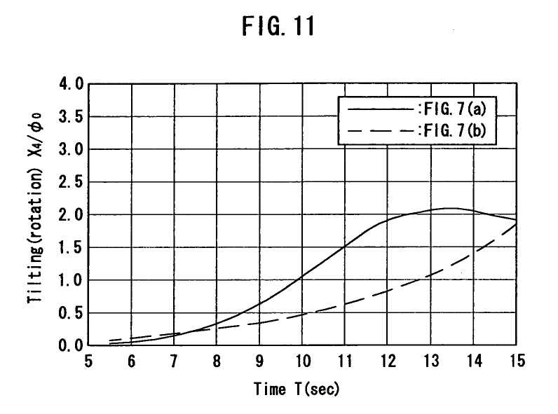

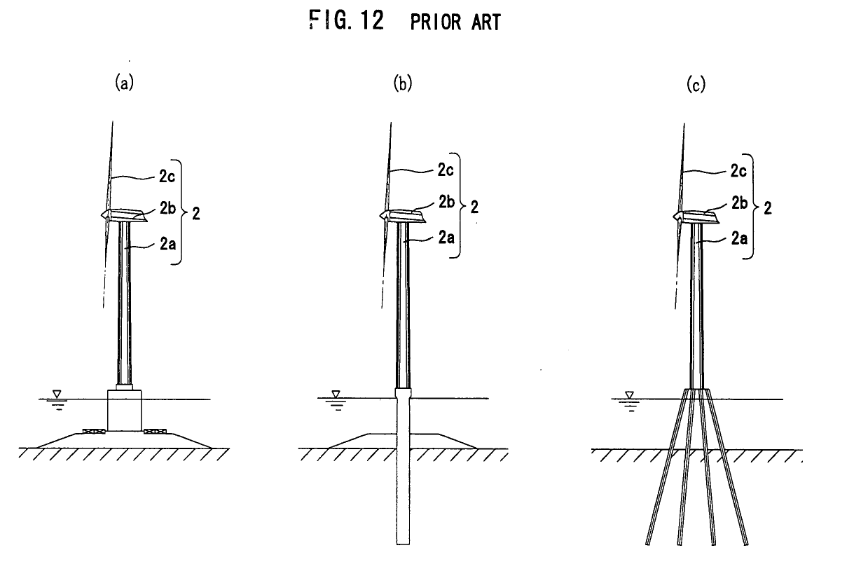

FIG. 9 is a graph illustrating the results of dividing the horizontal motion illustrated in FIG. 8(a), namely the amplitude X2 (m) of horizontal motion, by the amplitude of the input wave ξ0 (m). FIG. 10 is a graph illustrating the results of dividing the vertical motion illustrated in FIG. 8(b), namely the amplitude X3 (m) of vertical motion, by the amplitude of the input wave ξ0 (m). FIG. 11 is a graph illustrating the results of dividing the tilting (rotation) illustrated in FIG. 8(c), namely the amplitude X4 (rad) of tilting (rotation), by the wave tilting amplitude of the input wave Ø0 (rad).

As is evident from these FIGS. 9-11, looking at the horizontal motion (FIG. 9), vertical motion (FIG. 10) and tilting (rotation) (FIG. 11) during the period in which the horizontal axis is 10-13 seconds, horizontal motion and tilting (rotation) were better in the example illustrated in FIG. 7(b) (dashed line). On the other hand, vertical motion was better in the example illustrated in FIG. 7(a) (continuous line).

From this, even when considering only a main floating body 3 consisting of a cylinder that is longer in the axial direction, one can see that by disposing it such that the central axis becomes vertical, the superior meritorious effect of suppression of horizontal motion and tilting (rotation) due to waves can be achieved. On the other hand, in vertical motion where the main floating body 3 exhibited poor performance, this can be improved by providing a plurality of auxiliary floating bodies 4 such that their upper portions are positioned on the ocean surface and they surround the main floating body 3.

### INDUSTRIAL USABILITY

As described above, not only is the floating-type foundation structure for offshore wind power generation according to the present invention virtually unaffected by water depth, but the ocean topography is no problem at all. Moreover, even in offshore areas where the oceanic wind speeds tend to increase, oscillations of the entire structure due to the external forces of waves and external forces of wind can be suppressed as much as possible. Furthermore, it is a compact structural form, so the construction and transport of power generation systems on the ocean can be performed extremely simply. In addition, with the floating-type foundation structure for offshore wind power generation according to the present invention, it is also possible to add the effect of an underwater reef where fish gather to its lower portion.

1. A floating-type foundation structure that supports a power generation system upon the ocean in the upright position, where the power generation system comprises a tower, a nacelle secured to the top end of the tower, and blades that are rotatably attached to the front end of this nacelle, the floating-type foundation structure comprising:
a main floating body comprising a cylinder that is longer in the axial direction disposed vertically to support the power generation system in the upright position; and
auxiliary floating bodies attached to the main floating body by trusses so as to surround the main floating body, wherein
the lower portion of the main floating body that supports the power generation system in the upright position is submerged in the ocean while the upper portions of the auxiliary floating bodies are positioned upon the ocean surface.

2. A floating-type foundation structure for offshore power generation according to claim 1, wherein a flat plate larger in diameter than the cross section of the main floating body is installed so as to be as close to horizontal as possible in the underwater portion below the waterline of the main floating body.

3. A floating-type foundation structure for offshore power generation according to claim 1 or claim 2, wherein resistance plates are provided in the underwater portion below the waterline of the auxiliary floating bodies.

4. A floating-type foundation structure for offshore power generation according to claim 1 or claim 2, wherein at least two oscillation-suppression members are moveably provided at opposite positions upon the circumference above the waterline of the foundation structure.

5. A floating-type foundation structure for offshore power generation according to claim 3, wherein at least two oscillation-suppression members are moveably provided at opposite positions upon the circumference above the waterline of the foundation structure.

6. A floating-type foundation structure for offshore power generation according to claim 4, wherein the oscillation-suppression members are independently moveable.

7. A floating-type foundation structure for offshore power generation according to claim 5, wherein the oscillation-suppression members are independently moveable.

8. A floating-type foundation structure for offshore power generation according to claim 1 or claim 2, wherein oscillation-suppression vanes for suppressing oscillation due to waves or wind are provided in the underwater portion of the foundation structure.

9. A floating-type foundation structure for offshore power generation according to claim 3, wherein oscillation-suppression vanes for suppressing oscillation due to waves or wind are provided in the underwater portion of the foundation structure.

10. A floating-type foundation structure for offshore power generation according to claim 4, wherein oscillation-suppression vanes for suppressing oscillation due to waves or wind are provided in the underwater portion of the foundation structure.

11. A floating-type foundation structure for offshore power generation according to claim 5, wherein oscillation-suppression vanes for suppressing oscillation due to waves or wind are provided in the underwater portion of the foundation structure.

12. A floating-type foundation structure for offshore power generation according to claim 6, wherein oscillation-suppression vanes for suppressing oscillation due to waves or wind are provided in the underwater portion of the foundation structure.

13. A floating-type foundation structure for offshore power generation according to claim 7, wherein oscillation-suppression vanes for suppressing oscillation due to waves or wind are provided in the underwater portion of the foundation structure.

14. A floating-type foundation structure for offshore power generation according to claim 1 or claim 2, wherein the auxiliary floating bodies each contain a stipulated amount of ballast water, and a pump is provided on at least one of each of the pairs of auxiliary floating bodies disposed opposite each other symmetrically about the center of the floating-type foundation structure, and the pump distributes the ballast water within the pairs of oppositely disposed auxiliary floating bodies.

15. A floating-type foundation structure for offshore power generation according to claim 3, wherein the auxiliary floating bodies each contain a stipulated amount of ballast water, and a pump is provided on at least one of each of the pairs of auxiliary floating bodies disposed opposite each other symmetrically about the center of the floating-type foundation structure, and the pump distributes the ballast water within the pairs of oppositely disposed auxiliary floating bodies.

16. A floating-type foundation structure for offshore power generation according to claim 8, wherein the auxiliary floating bodies each contain a stipulated amount of ballast water, and a pump is provided on at least one of each of the pairs of auxiliary floating bodies disposed opposite each other symmetrically about the center of the floating-type foundation structure, and the pump distributes the ballast water within the pairs of oppositely disposed auxiliary floating bodies.

17. A floating-type foundation structure for offshore power generation according to claim 9, wherein the auxiliary floating bodies each contain a stipulated amount of ballast water, and a pump is provided on at least one of each of the pairs of auxiliary floating bodies disposed opposite each other symmetrically about the center of the floating-type foundation structure, and the pump distributes the ballast water within the pairs of oppositely disposed auxiliary floating bodies.

18. A floating-type foundation structure for offshore power generation according to claim 14, wherein a pump is provided in a portion excluding the auxiliary floating bodies of the foundation structure, so that the ballast water to be distributed can be replenished.

19. A floating-type foundation structure for offshore power generation according to claim 15, wherein a pump is provided in a portion excluding the auxiliary floating bodies of the foundation structure, so that the ballast water to be distributed can be replenished.

20. A floating-type foundation structure for offshore power generation according to claim 16, wherein a pump is provided in a portion excluding the auxiliary floating bodies of the foundation structure, so that the ballast water to be distributed can be replenished.

21. A floating-type foundation structure for offshore power generation according to claim 17, wherein a pump is provided in a portion excluding the auxiliary floating bodies of the foundation structure, so that the ballast water to be distributed can be replenished.
